(19) United States
(12) Patent Application Publication
(10) Pub. No.: US 2007/0035955 A1
(43) Pub. Date: Feb. 15, 2007

(54) Light for use for a passenger seat

(75) Inventor: Carsten Puschmann, Hamburg (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/340,265

(22) Filed: Jan. 26, 2006

Related U.S. Application Data
(60) Provisional application No. 60/647,518, filed on Jan. 27, 2005.

(30) Foreign Application Priority Data
Jan. 27, 2005 (DE) 10 2005 003 873.5

(51) Int. Cl. B64D 47/02

(52) U.S. Cl. 362/472

(57) ABSTRACT

A lighting element for use for a passenger seat may be integrated in a backrest of the passenger seat, particularly to illuminate an area behind the passenger seat.

### REFERENCE TO RELATED APPLICATIONS

This application claims the benefit of the filing date of U.S. Provisional Patent Application No. 60/647,518 filed Jan. 27, 2005, the disclosure of which is hereby incorporated herein by reference and of German Patent Application DE 10 2005 003 873.5 filed Jan. 27, 2005, the disclosure of which is hereby incorporated herein by reference.

### FIELD OF THE INVENTION

The present invention relates to a light for a passenger seat, particularly for a passenger seat which is positioned in seat rows in an aircraft.

### TECHNOLOGICAL BACKGROUND

In conventional designs of aircraft cabins, the distance between a passenger seat and the bottom of a hat rack (a baggage compartment, for example) directly above the passenger seat is great. Reading lights and switches for the reading lights are typically attached below the hat racks, and are thus far from the passengers. Therefore, passengers may not reach the switches from the seated position. Since the reading lights are further from the passengers, illumination is additionally poorer.

### SUMMARY OF THE INVENTION

A light which may be used by a passenger sitting in a seat having an armrest, with each of the seats for each of the passengers have a backrest, includes a light element that is integratable in one of the backrests and a switch element which is integratable in the armrest such that the switch element is electrically coupled with the light element for a passenger's use. Thus, a passenger may have the ability to move the reading lights and the switches independently of the position of the hat rack.

In one example, a light may be positioned above a folding table attached to the backrest.

In one example of the present invention, the light and a switch may be installed as an integrated unit or independently from one another in the backrest.

According to another embodiment of the present invention, the light is installed closer to the area to be illuminated, through which the illumination is improved. The lighting power of the lights may thus also be reduced with the same illumination, commercially available lights being able to be used, such as incandescent lamps, halogen lights, LEDs, etc. Furthermore, the switch for a light may be reached more easily.

According to an embodiment of the present invention, the position of the hat racks (baggage storage compartment, for example.) may be varied, since the light may be installed independently of the hat racks (baggage storage compartment, for example.)

### BRIEF DESCRIPTION OF THE DRAWINGS

The drawings illustrate examples of the present invention, but the invention should not be limited merely to the examples disclosed.

FIG. 1 shows a schematic illustration of an aircraft cabin (detail).

FIG. 2 depicts a perspective view of two passenger seats having integratable reading lights from the rear.

FIG. 3 shows a schematic view of multiple passenger seats having integratable reading lights from the side.

FIG. 4 shows a schematic illustration of a further embodiment of the present invention.

FIG. 5 shows a side view of the embodiment of FIG. 4.

### DETAILED DESCRIPTION OF PREFERRED EMBODIMENTS

The detailed description and drawings provide some examples of the present invention, but the present invention should not be limited merely to the examples disclosed. Instead, the invention should be limited only by the claims that may eventually issue. Many variations in the present invention, changes in specific components of the present invention, and uses of the present invention will be readily apparent to those familiar with the field based on the drawings and descriptions provided.

In the following, identical or similar elements are provided with identical reference numbers in the figures.

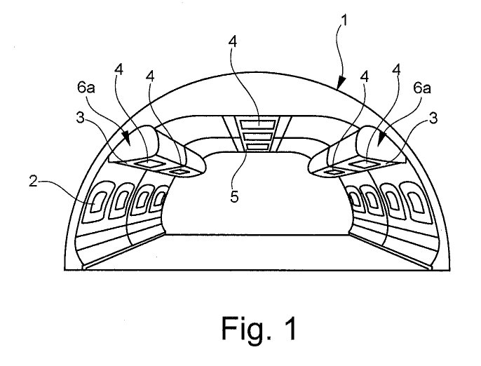

FIG. 1 shows a schematic illustration of an aircraft cabin 1 (detail). Channels 3 (lateral service channels) are positioned on the baggage storage 6a of the aircraft cabin 1 running in the longitudinal direction of the aircraft fuselage above windows 2. PSIUs 4 (passenger service information units), which contain displays for “no smoking” or “fasten seat belts” are located on the bottom of the channels 3.

In conventional designs of aircraft cabins, a central service channel 5, which has the same function and object as the lateral service channels 3, is located directly in the ceiling of aircraft cabin 1 between the lateral service channels 3, running in the longitudinal direction of the aircraft fuselage. The central service channel 5 also has multiple PSIUs 4 positioned in the longitudinal direction of the aircraft fuselage.

Typically, multiple seat rows (not shown in FIG. 1) positioned in the longitudinal direction of the aircraft fuselage are mounted directly below the lateral service channels 3 and below the central service channel 5. The PSIUs' 4 of the lateral service channels 3 and the central service channel 5 generally contain reading lights and corresponding switches for turning the reading lights on and off for each seat and/or each seat row.

In the design of an aircraft cabin 1 shown in FIG. 1, passengers seated directly below the central service channel 5 may find it difficult to reach the switches for turning the reading lights on and off, since the central service channel 5 is integrated directly into the ceiling 6 of the aircraft cabin 1.

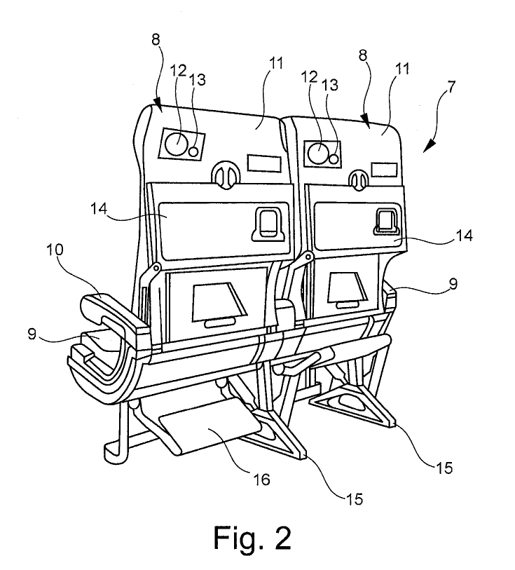

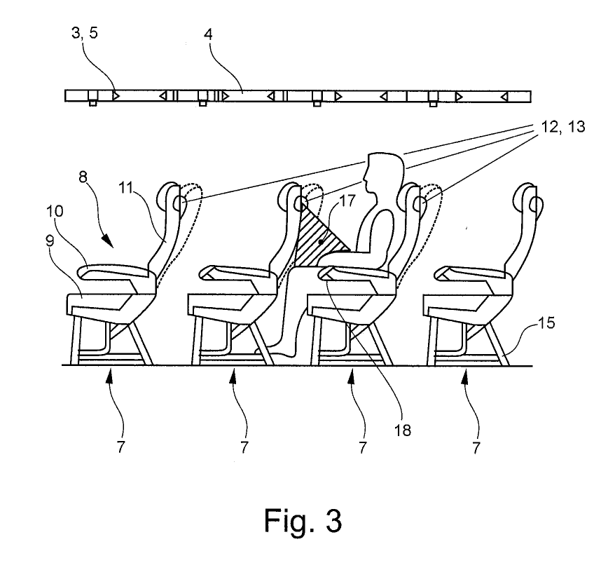

FIG. 2 shows a seat row 7 having two passenger seats 8, which is positioned directly below the central service channel 5 shown in FIG. 1, for example. A passenger seat 8 having a seat surface 9, an armrest 10, and a backrest 11 is shown. The cover of the backrest is cut out appropriately in an upper area of the backrest 11 to receive a reading light 12 and a corresponding switch 13. In one preferred embodiment, the reading light 12 and the switch 13 are located above a folding table 14, which is shown folded against the backrest. The reading light 12 and the switch 13 are integrated as a unit in the backrest 11, for example. A corresponding reading light 12 may be turned on and off via the switch 13. Additionally, devices 15 below a footrest 16 for attaching the passenger seat 8 and/or the seat row 7 to the floor of the aircraft cabin 1, are shown in FIG. 3.

FIG. 3 shows four seat rows 7 from the side. The seat rows 7 are positioned below the lateral service channels 3 and/or below the central service channels 5 in such a way that a PSIU 4 is positioned directly above each passenger seat 8. According to an embodiment of the present invention, the PSIUs' no longer need to contain a reading light and a corresponding switch, since they are integratable or capable of being integrated in the backrest 11 of a passenger seat 8, as shown in FIG. 3.

A light described in examples of the present invention include reading lights. The reading light 12 has a light cone 17 such that an optimum illumination is produced in such a way that a person seated on the passenger seat 8 is not blinded and the lap area of the person is preferably well illuminated. As indicated by the dashed line in FIG. 3, the backrest 11 may be inclined to the rear. Thus, the reading light 12 is integratable in the backrest 11 in such a way that a person may pivot the reading lamp in order to be able to adapt the light cone 17 to his requirements, for example. This adaption may occur automatically as a function of the position of the backrest in which the reading lamp is integrated. If reading lamp and switch are integrated as a unit, the entire unit may be pivotable, for example.

As shown in FIG. 3, the armrest 10 contains a switch 18 in order to turn the reading light 12 that is integrable into the backrest 11 of the forward passenger seat 8, on and off, for example. This switch 18 may be provided alternatively or additionally to the switch 13 implemented in the backrest 11.

Although embodiments of the present invention were described in detail with reference to the attached drawing above, it is obvious that modifications and changes may be performed without leaving the protective scope of the present invention. For example, only one reading light may be provided for illuminating multiple passenger seats or the seat row located behind it. Furthermore, other examples of the present invention in areas other than aircraft may be used in other transport vehicles such as buses, ships, etc.

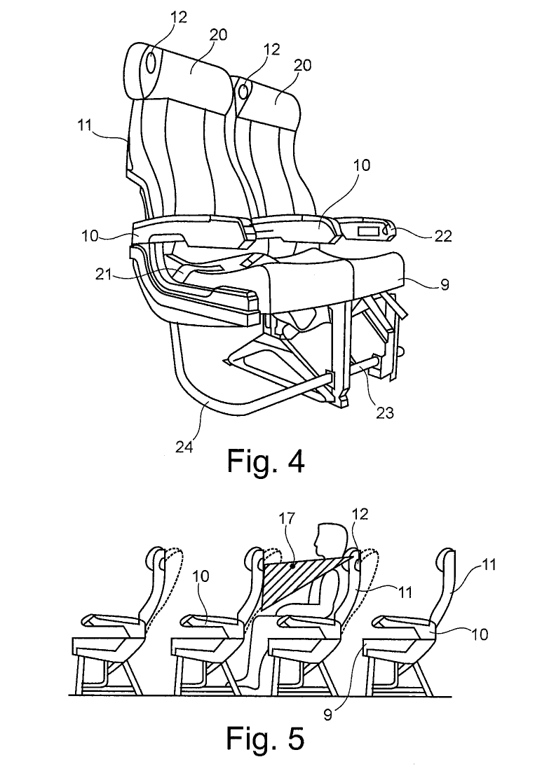

In another embodiment shown in FIG. 4, reading lights 12 are integrable into lateral areas of a cushion 20 of the backrest 11. For example, the cushion 20 may have an area with especially hard cushioning for receiving the reading lights 12 for this purpose. Furthermore, attachments may also be positioned in a soft pad of the cushion 20. The reading lights 12 are positioned in lateral areas in such a way that when a person sits on the seat, the reading lights 12 are located to the right (or also left) of the head of the seated person. In this way, it may be ensured that a light cone generated by the reading light 12 may fall on the area to be illuminated that is unobstructed laterally of the head of the person. Thus, light falls laterally of the person that is seated and is unobstructed.

The reading lights 12 are integratable into a forward area of the backrest 11 in such a way, particularly into a lateral area of the cushion 20 of a head rest of the seat, such that a light cone 17 generated by the reading light 12 is positioned forward. Thus, the reading light is positioned in such a way that an area for the person seated in the seat is illuminated. As shown in FIG. 5, for example, the light cone 17 falls forward into the lap area of then person seated in the seat.

In particular, the reading lights 12 are oriented in such a way, that the light cone 17 falls forward into the lap area of the person seated in the seat. In another example, the reading lights may also be adjustable in such a way, that the light cone also illuminates a work area, such as a folding table on the back of the forward seat, such that the person may work, or alternatively, the light cone 17 also directly illuminates a lap area of the person. The lap area includes the area from the knee to the hip, so that the person may read well with a magazine on his lap. As a result, as defined in the present invention, “lap area” is to be understood to mean that a work area or direct lap area or an area to which the person has access is encompassed by the light cone 17 or the reading lights 12 are adjustable in such a way that the light cone 17 may be directed to partial areas of this overall area.

As may be inferred from FIG. 4, the seat arrangement, i.e., the two seats next to one another, have a frame 23 on which a baggage frame 24, among other things, is positioned in order to prevent baggage lying under the seat from being able to slip forward in the event of emergency braking, for example. The seat also has a safety belt 21 for the person. The armrests 10 may, for example, be constructed in such a way that the outer armrests are fixed and only the middle armrest is adjustable.

The reference number 22 identifies a backrest switch, which allows for an inclination of the backrest to be changed. For example, a further switch may be provided in the area of this switch 22 (or integrated therewith) in order to actuate the reading lights 12. Switches may also be provided directly on the housing in the reading lights 12 in order to activate the reading lights and/or to adjust the direction or also the size of the light cone 17 that is emitted by the reading lights.

In another example, it may be sufficient to have only one reading light 12 integratable at a time in the way shown in the seats. However, in another example, two separate reading lights to illuminate the lap area of the person using two separate reading lights, may be used. Thus, for example, a reading light may be provided on both sides of the cushion 20 of the particular seat.

List of Reference Numbers

1 aircraft cabin
2 window
3 lateral service channels
4 PSIU
5 central service channel
6 ceiling
6a baggage storage (hat rack)
7 seat row
8 passenger seat
9 seat surface
10 armrest
11 backrest
12 reading light
13 switch
14 folding table
15 device
16 foot rest
17 light cone
18 switch (armrest)
20 cushion
21 belt
22 backrest switch
23 frame
24 baggage frame

What is claimed:

1: A light for use by a passenger sitting in a seat having an armrest, each of the seats for each of the passengers, having a backrest, the light comprising:
a light element integratable in one of the backrests; and
a switch element integratable in the armrest of the passenger such that the switch element is electrically coupled with the light element for use by the passenger.

2: The light of claim 1, wherein the light element is integratable in one of the backrests disposed to the front of the passenger.

3: The light of claim 2, wherein the light element is integratable at a position above a folding table in the backrest.

4: The light of claim 1, further comprising another switch element integrated in the light element.

5: The light of claim 1, further comprising another switch element integratable in the backrests of the seats separate from the light element.

6: The light of claim 1, wherein the light element is integratable in one of the backrests such that in a respective one of the backrests, a light cone emitted by the light element illuminates a lap area of the passenger in a seat forward of the respective one of the backrests.

7: The light of claim 6, wherein the light element is integratable in a forward facing area of the respective one of the backrests.

8: The light element of claim 7, wherein the lighting element is integrated in a lateral area of a cushion integratable as a headrest of the respective one of the backrests.
